(19) United States
(12) Patent Application Publication
(10) Pub. No.: US 2023/0171259 A1
(43) Pub. Date: Jun. 1, 2023

(54) METHOD AND APPARATUS FOR PROTECTING DATA IN MACHINE TO MACHINE SYSTEM

(71) Applicants: Hyundai Motor Company, Seoul (KR); Kia Corporation, Seoul (KR); Industry Academy Cooperation Foundation of Sejong University, Seoul (KR)

(72) Inventor: Jae Seung Song, Seoul (KR)

(21) Appl. No.: 18/070,245

(22) Filed: Nov. 28, 2022

Related U.S. Application Data
(60) Provisional application No. 63/283,586, filed on Nov. 29, 2021.

(51) Int. Cl. H04L 9/40

(52) U.S. Cl. CPC H04L 63/104

(57) ABSTRACT

The present disclosure may protect data in a machine-to-machine (M2M) system. A method for operating a first device in the M2M system may include: receiving, from a second device, data including an original value generated by the second device; obtaining at least one representation value corresponding to the original value; and storing the original value and the at least one representation value in a resource for storing the data generated by the second device.

### CROSS REFERENCE TO RELATED APPLICATION

The present application claims priority to a U.S. provisional application 63/283,586, filed Nov. 29, 2021, the entire contents of which is incorporated herein for all purposes by this reference.

### BACKGROUND OF THE DISCLOSURE

### Field of the Disclosure

The present disclosure relates to a machine-to-machine (M2M) system and, more particularly, to a method and apparatus for protecting data in an M2M system.

### Description of the Related Art

Recently, introduction of Machine-to-Machine (M2M) system has become active. An M2M communication may refer to a communication performed between machines without human intervention. M2M may refer to Machine Type Communication (MTC), Internet of Things (IoT) or Device-to-Device (D2D). In the following description, the term “M2M” may be uniformly used for convenience of explanation, but the present disclosure may not be limited thereto. A terminal used for M2M communication may be an M2M terminal or an M2M device. An M2M terminal may generally be a device having low mobility while transmitting a small amount of data. Herein, the M2M terminal may be used in connection with an M2M server that centrally stores and manages inter-machine communication information. In addition, an M2M terminal may be applied to various systems such as object tracking, automobile linkage, and power metering.

Meanwhile, with respect to an M2M terminal, the oneM2M standardization organization provides requirements for M2M communication, things to things communication and IoT technology, and technologies for architecture, Application Program Interface (API) specifications, security solutions and interoperability. The specifications of the oneM2M standardization organization provide a framework to support a variety of applications and services such as smart cities, smart grids, connected cars, home automation, security and health.

### SUMMARY

The present disclosure provides a method and apparatus for effectively protecting data in a machine-to-machine (M2M) system.

The present disclosure provides a method and apparatus for storing data by allowing it to have multiple values in an M2M system.

The present disclosure provides a method and apparatus for managing data with multiple values in an M2M system.

The present disclosure provides a method and apparatus for managing a resource including information on data with multiple values in an M2M system.

According to an embodiment, a method for operating a first device in a machine-to-machine (M2M) system may include: receiving, from a second device, data including an original value generated by the second device; obtaining at least one representation value corresponding to the original value; and storing the original value and the at least one representation value in a resource for storing the data generated by the second device.

According to an embodiment, a first device in a machine-to-machine (M2M) system may include a transceiver and a processor coupled with the transceiver, and the processor may be configured to receive, from a second device, data including an original value generated by the second device, to obtain at least one representation value corresponding to the original value, and to store the original value and the at least one representation value in a resource for storing the data generated by the second device.

According to the present disclosure, data may be effectively protected in a machine-to-machine (M2M) system.

Effects obtained in the present disclosure may not be limited to the above-mentioned effects, and other effects not mentioned above may be clearly understood by those skilled in the art from the following description.

### BRIEF DESCRIPTION OF THE DRAWINGS

The above and other objects, features and advantages of the present disclosure will be more clearly understood from the following detailed description taken in conjunction with the accompanying drawings.

FIG. 1 illustrates a layered structure of a machine-to-machine (M2M) system according to the present disclosure.

FIG. 2 illustrates a reference point in an M2M system according to the present disclosure.

FIG. 3 illustrates each node in an M2M system according to the present disclosure.

FIG. 4 illustrates a common service function in an M2M system according to the present disclosure.

FIG. 5 illustrates a method in which an originator and a receiver exchange a message in an M2M system according to the present disclosure.

FIG. 6 illustrates a concept of data with multiple values in an M2M system according to the present disclosure.

FIG. 7A and FIG. 7B illustrate examples of resources related to data with multiple values in an M2M system according to the present disclosure.

FIG. 8 illustrates an example of a procedure of processing data with multiple values in an M2M system according to the present disclosure.

FIG. 9 illustrates an example of a procedure of generating and discovering data with multiple values in an M2M system according to the present disclosure.

FIG. 10 illustrates another example of a procedure of generating and discovering data with multiple values in an M2M system according to the present disclosure.

FIG. 11 illustrates a configuration of an M2M device in an M2M system according to the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In the present disclosure, the terms first, second, etc. may be used only for the purpose of distinguishing one component from another, and do not limit the order or importance of components, etc. unless specifically stated otherwise. Thus, within the scope of this disclosure, a first component in one embodiment may be referred to as a second component in another embodiment, and similarly a second component in one embodiment may be referred to as a first component. In addition, as understood by a person of skill in the art reading the present disclosure, the components may not be separated, but merely indicate different functions for a single component structure. For example, a first memory for storing data A and a second memory for storing data B may include either separate memory for storing the separate data or could, in fact, be implemented in a single memory unit that stores both data A and data B.

In the present disclosure, when a component may be referred to as being “linked”, “coupled”, or “connected” to another component, it may be understood that not only a direct connection relationship but also an indirect connection relationship through an intermediate component may also be included. Also, when a component may be referred to as “comprising” or “having” another component, it may mean further inclusion of another component not the exclusion thereof, unless explicitly described to the contrary.

In the present disclosure, components that may be distinguished from each other may be intended to clearly illustrate each feature. However, it does not necessarily mean that the components may be separate. In other words, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment may be also included within the scope of the present disclosure. Also, exemplary embodiments that include other components in addition to the components described in the various exemplary embodiments may also be included in the scope of the present disclosure.

In the following description of the embodiments of the present disclosure, a detailed description of known functions and configurations incorporated herein will be omitted when it may make the subject matter of the present disclosure rather unclear. Parts not related to the description of the present disclosure in the drawings may be omitted, and like parts may be denoted by similar reference numerals.

Although an exemplary embodiment may be described as using a plurality of units to perform the exemplary process, it may be understood that the exemplary processes may also be performed by one or plurality of modules. Additionally, it may be understood that the term controller/control unit refers to a hardware device that includes a memory and a processor and may be specifically programmed to execute the processes described herein. The memory may be configured to store the modules and the processor may be specifically configured to execute said modules to perform one or more processes which may be described further below.

In addition, the present specification describes a network based on Machine-to-Machine (M2M) communication, and a work in M2M communication network may be performed in a process of network control and data transmission in a system managing the communication network. In the present specification, an M2M terminal may be a terminal performing M2M communication. However, in consideration of backward compatibility, it may be a terminal operating in a wireless communication system. In other words, an M2M terminal may refer to a terminal operating based on M2M communication network but may not be limited thereto. An M2M terminal may operate based on another wireless communication network and may not be limited to the exemplary embodiment described above.

In addition, an M2M terminal may be fixed or have mobility. An M2M server refers to a server for M2M communication and may be a fixed station or a mobile station. In the present specification, an entity may refer to hardware like M2M device, M2M gateway and M2M server. In addition, for example, an entity may be used to refer to software configuration in a layered structure of M2M system and may not be limited to the embodiment described above.

In addition, for example, the present disclosure mainly describes an M2M system but may not be solely applied thereto. In addition, an M2M server may be a server that performs communication with an M2M terminal or another M2M server. In addition, an M2M gateway may be a connection point between an M2M terminal and an M2M server. For example, when an M2M terminal and an M2M server have different networks, the M2M terminal and the M2M server may be connected to each other through an M2M gateway. Herein, for example, both an M2M gateway and an M2M server may be M2M terminals and may not be limited to the embodiment described above.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The present disclosure relates to a method and device for protecting data in an machine-to-machine (M2M) system. Particularly, the present disclosure describes a technology of storing data by allowing it have a plurality of values in an M2M system.

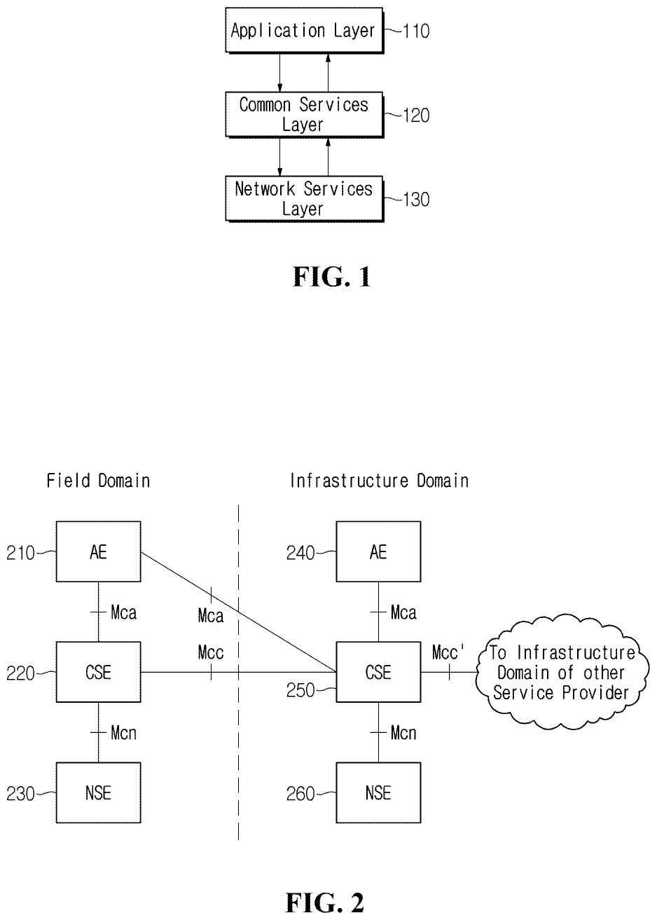

oneM2M may be a de facto standards organization that was founded to develop a communal IoT service platform sharing and integrating application service infrastructure (platform) environments beyond fragmented service platform development structures limited to separate industries like energy, transportation, national defense and public service. oneM2M aims to render requirements for things to things communication and IoT technology, architectures, Application Program Interface (API) specifications, security solutions and interoperability. For example, the specifications of oneM2M provide a framework to support a variety of applications and services such as smart cities, smart grids, connected cars, home automation, security and health. In this regard, oneM2M has developed a set of standards defining a single horizontal platform for data exchange and sharing among all the applications. Applications across different industrial sections may also be considered by oneM2M. Like an operating system, oneM2M provides a framework connecting different technologies, thereby creating distributed software layers facilitating unification. Distributed software layers may be implemented in a common services layer between M2M applications and communication Hardware/Software (HW/SW) rendering data transmission. For example, a common services layer may be a part of a layered structure illustrated in FIG. 1. The oneM2M standards are referred to herein and incorporated in their entirety into this application. Specifically, the technical specification of the oneM2M Functional Architecture is referred to herein and incorporated herein in its entirety. See Document No. TS-0001-V4.8.0, Functional Architecture and Document No. TS-0001-V3.15.1, Functional Architecture.

FIG. 1 illustrates a layered structure of an Machine-to-Machine (M2M) system according to the present disclosure. Referring to FIG. 1, a layered structure of an M2M system may include an application layer 110, a common services layer 120 and a network services layer 130. Herein, the application layer 110 may be configured as a layer operating based on a specific application. For example, an application may be a fleet tracking application, a remote blood sugar monitoring application, a power metering application or a controlling application. In other words, an application layer may be a layer for a specific application. Herein, an entity operating based on an application layer may be an application entity (AE).

The common services layer 120 may be configured as a layer for a common service function (CSF). For example, the common services layer 120 may be a layer for providing common services like data management, device management, M2M service subscription management and location service. For example, an entity operating based on the common services layer 120 may be a common service entity (CSE).

The common services layer 120 may be configured to provide a set of services that may be grouped into CSFs according to functions. A multiplicity of instantiated CSFs constitutes CSEs. CSEs may interface with applications (for example, application entities or AEs in the terminology of oneM2M), other CSEs and base networks (for example, network service entities or NSEs in the terminology of oneM2M). The network services layer 130 may be configured to provide the common services layer 120 with services such as device management, location service and device triggering. Herein, an entity operating based on the network layer 120 may be a network service entity (NSE).

FIG. 2 illustrates reference points in an M2M system according to the present disclosure. Referring to FIG. 2, an M2M system structure may be distinguished into a field domain and an infrastructure domain. Herein, in each domain, each of the entities may perform communication through a reference point (for example, Mca or Mcc). For example, a reference point may indicate a communication flow between each entity. In particular, referring to FIG. 2, the reference point Mca between AE 210 or 240 and CSE 220 or 250, the reference point Mcc between different CSEs and Mcn reference point between CSE 220 or 250 and NSE 230 or 260 may be set.

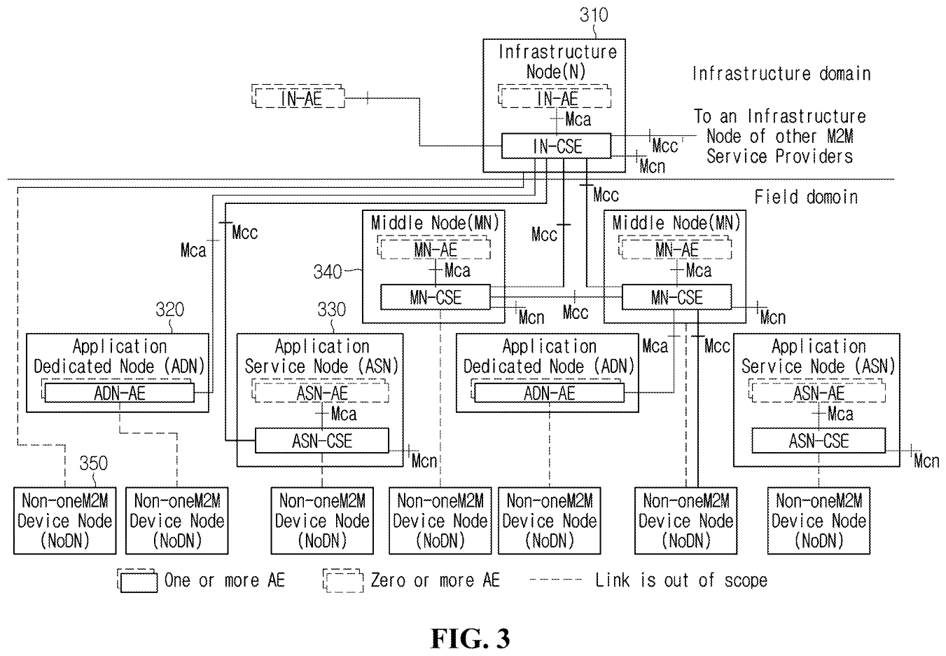

FIG. 3illustrates each node in an M2M system according to the present disclosure. Referring to FIG. 3, an infrastructure domain of a specific M2M service provider may be configured to provide a specific infrastructure node (IN) 310. Herein, the CSE of the IN may be configured to perform communication based on the AE and the reference point Mca of another infrastructure node. In particular, one IN may be set for each M2M service provider. In other words, the IN may be a node that performs communication with the M2M terminal of another infrastructure based on an infrastructure structure. In addition, for example, conceptually, a node may be configured as a logical entity or a software configuration.

Next, an application dedicated node (ADN) 320 may be a node including at least one AE but not CSE. In particular, an ADN may be set in the field domain. In other words, an ADN may be a dedicated node for AE. For example, an ADN may be a node that may be set in an M2M terminal in hardware. In addition, the application service node (ASN) 330 may be a node including one CSE and at least one AE. ASN may be set in the field domain. In other words, it may be a node including AE and CSE. In particular, an ASN may be a node connected to an IN. For example, an ASN may be a node that may be set in an M2M terminal in hardware.

In addition, a middle node (MN) 340 may be a node including a CSE and including zero or more AEs. In particular, the MN may be set in the field domain. An MN may be connected to another MN or IN based on a reference point. In addition, for example, an MN may be set in an M2M gateway in hardware. As an example, a non-M2M terminal node 350 (Non-M2M device node, NoDN) may be a node that does not include M2M entities. It may be a node that performs management or collaboration together with an M2M system.

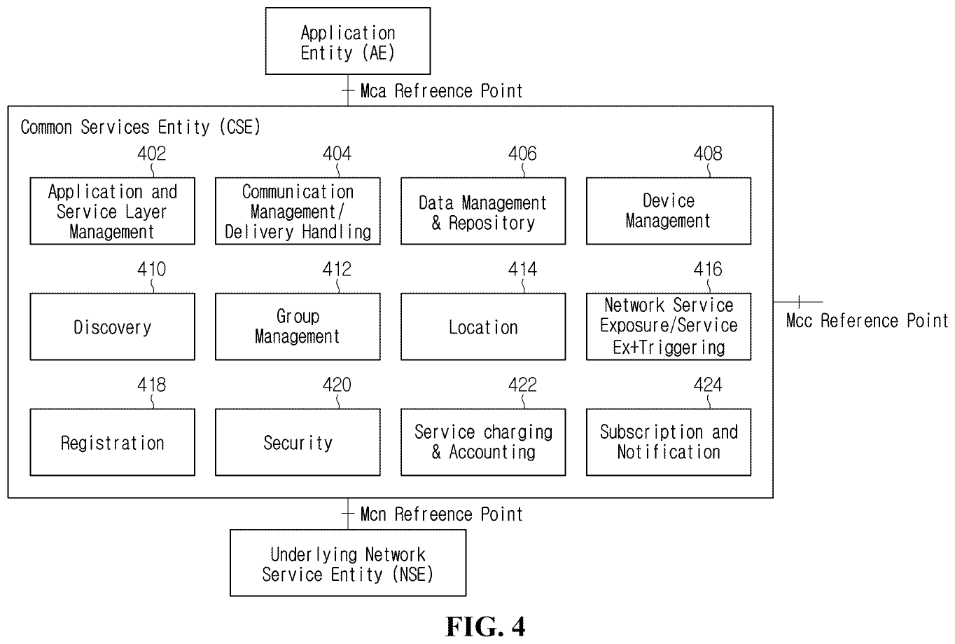

FIG. 4 illustrates a common service function in an M2M system according to the present disclosure. Referring to FIG. 4, common service functions may be provided. For example, a common service entity may be configured to provide at least one or more CSFs among application and service layer management 402, communication management and delivery handling 404, data management and repository 406, device management 408, discovery 410, group management 412, location 414, network service exposure/service execution and triggering 416, registration 418, security 420, service charging and accounting 422, service session management and subscription/notification 424. At this time, M2M terminals may operate based on a common service function. In addition, a common service function may be possible in other embodiments and may not be limited to the above-described exemplary embodiment.

The application and service layer management 402 CSF may be configured to provide management of AEs and CSEs. The application and service layer management 402 CSF may be configured to include not only the configuring, problem solving and upgrading of CSE functions but also the capability of upgrading AEs. The communication management and delivery handling 404 CSF may be configured to provide communications with other CSEs, AEs and NSEs. The communication management and delivery handling 404 CSF may be configured to determine at what time and through what connection communications may be delivered, and also determine to buffer communication requests to deliver the communications later, if necessary and permitted.

The data management and repository 406 CSF may be configured to provide data storage and transmission functions (for example, data collection for aggregation, data reformatting, and data storage for analysis and sematic processing). The device management 408 CSF may be configured to provide the management of device capabilities in M2M gateways and M2M devices.

The discovery 410 CSF may be configured to provide an information retrieval function for applications and services based on filter criteria. The group management 412 CSF may be configured to provide processing of group-related requests. The group management 412 CSF may be configured to enable an M2M system to support bulk operations for many devices and applications. The location 414 CSF may be configured to enable AEs to obtain geographical location information.

The network service exposure/service execution and triggering 416 CSF may be configured to manage communications with base networks for access to network service functions. The registration 418 CSF may be configured to provide AEs (or other remote CSEs) to a CSE. The registration 418 CSF may be configured to allow AEs (or remote CSE) to use services of CSE. The security 420 CSF may be configured to provide a service layer with security functions like access control including identification, authentication and permission. The service charging and accounting 422 CSF may be configured to provide charging functions for a service layer. The subscription/notification 424 CSF may be configured to allow subscription to an event and notifying the occurrence of the event.

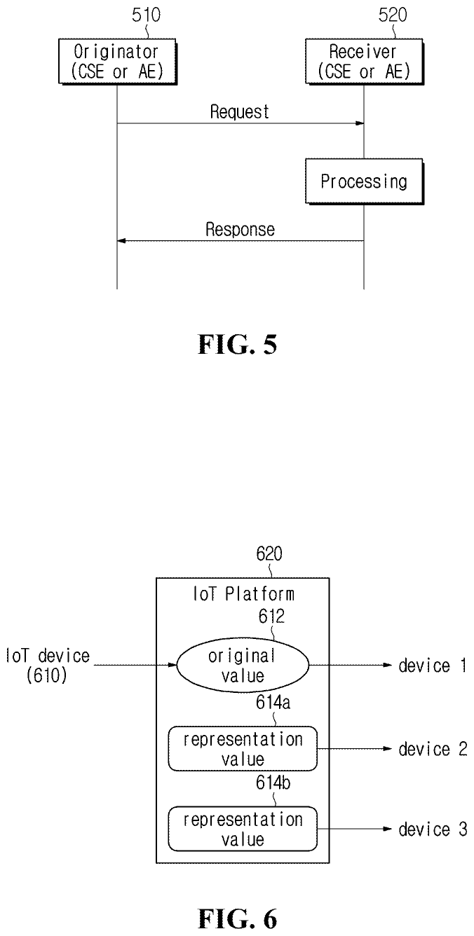

FIG. 5 illustrates an exchange of a message between an originator and a receiver in an M2M system according to the present disclosure. Referring to FIG. 5, the originator 501 may be configured to transmit a request message to the receiver 520. In particular, the originator 510 and the receiver 520 may be the above-described M2M terminals. However, the originator 510 and the receiver 520 may not be limited to M2M terminals but may be other terminals. They may not be limited to the above-described exemplary embodiment. In addition, for example, the originator 510 and the receiver 520 may be nodes, entities, servers or gateways, which may be described above. In other words, the originator 510 and the receiver 520 may be hardware or software configurations and may not be limited to the above-described embodiment.

Herein, for example, a request message transmitted by the originator 510 may include at least one parameter. Additionally, a parameter may be a mandatory parameter or an optional parameter. For example, a parameter related to a transmission terminal, a parameter related to a receiving terminal, an identification parameter and an operation parameter may be mandatory parameters. In addition, optional parameters may be related to other types of information. In particular, a transmission terminal-related parameter may be a parameter for the originator 510. In addition, a receiving terminal-related parameter may be a parameter for the receiver 520. An identification parameter may be a parameter required for identification of each other.

Further, an operation parameter may be a parameter for distinguishing operations. For example, an operation parameter may be set to any one among Create, Retrieve, Update, Delete or Notify. In other words, the parameter may aim to distinguish operations. In response to receiving a request message from the originator 510, the receiver 520 may be configured to process the message. For example, the receiver 520 may be configured to perform an operation included in a request message. For the operation, the receiver 520 may be configured to determine whether a parameter may be valid and authorized. In particular, in response to determining that a parameter may be valid and authorized, the receiver 520 may be configured to check whether there may be a requested resource and perform processing accordingly.

For example, in case an event occurs, the originator 510 may be configured to transmit a request message including a parameter for notification to the receiver 520. The receiver 520 may be configured to check a parameter for a notification included in a request message and may perform an operation accordingly. The receiver 520 may be configured to transmit a response message to the originator 510.

A message exchange process using a request message and a response message, as illustrated in FIG. 5, may be performed between AE and CSE based on the reference point Mca or between CSEs based on the reference point Mcc. In other words, the originator 510 may be AE or CSE, and the receiver 520 may be AE or CSE. According to an operation in a request message, such a message exchange process as illustrated in FIG. 5 may be initiated by either AE or CSE.

A request from a requestor to a receiver through the reference points Mca and Mcc may include at least one mandatory parameter and at least one optional parameter. In other words, each defined parameter may be either mandatory or optional according to a requested operation. For example, a response message may include at least one parameter among those listed in Table 1 below.

TABLE 1
Response message parameter/success or not

Response Status Code - successful, unsuccessful, ack
Request Identifier - uniquely identifies a Request message
Content - to be transferred
To - the identifier of the Originator or the Transit CSE
that sent the corresponding non-blocking request
From - the identifier of the Receiver
Originating Timestamp - when the message was built
Result Expiration Timestamp - when the message expires
Event Category - what event category shall be used for
the response message
Content Status
Content Offset
Token Request Information
Assigned Token Identifiers
Authorization Signature Request Information
Release Version Indicator - the oneM2M release version that this
response message conforms to

A filter criteria condition, which may be used in a request message or a response message, may be defined as in Table 2 and Table 3 below.

TABLE 2

| | | |
|---|---|---|
| Condition tag | Multiplicity | Description |

Matching Conditions

| | | |
|---|---|---|
| createdBefore | 0 . . . 1 | The creationTime attribute of the matched resource is |
| | | chronologically before the specified value. |
| createdAfter | 0 . . . 1 | The creationTime attribute of the matched resource is |
| | | chronologically after the specified value. |
| modifiedSince | 0 . . . 1 | The lastModifiedTime attribute of the matched resource is |
| | | chronologically after the specified value. |
| unmodifiedSince | 0 . . . 1 | The lastModifiedTime attribute of the matched resource is |
| | | chronologically before the specified value. |
| stateTagSmaller | 0 . . . 1 | The stateTag attribute of the matched resource is smaller than the |
| | | specified value. |
| stateTagBigger | 0 . . . 1 | The stateTag attribute of the matched resource is bigger than the |
| | | specified value. |
| expireBefore | 0 . . . 1 | The expirationTime attribute of the matched resource is |
| | | chronologically before the specified value. |
| expireAfter | 0 . . . 1 | The expirationTime attribute of the matched resource is |
| | | chronologically after the specified value. |
| labels | 0 . . . 1 | The labels attribute of the matched resource matches the specified |
| | | value. |
| labelsQuery | 0 . . . 1 | The value is an expression for the filtering of labels attribute of |
| | | resource when it is of key-value pair format. The expression is |
| | | about the relationship between label-key and label-value which |
| | | may include equal to or not equal to, within or not within a |
| | | specified set etc. For example, label-key equals to label value, or |
| | | label-key within {label-value1, label-value2}. |
| childLabels | 0 . . . 1 | A child of the matched resource has labels attributes matching the |
| | | specified value. The evaluation is the same as for the labels |
| | | attribute above. |
| parentLabels | 0 . . . 1 | The parent of the matched resource has labels attributes matching |
| | | the specified value. The evaluation is the same as for the labels |
| | | attribute above. |
| resourceType | 0 . . . n | The resourceType attribute of the matched resource is the same as |
| | | the specified value. It also allows differentiating between normal |
| | | and announced resources. |
| childResourceType | 0 . . . n | A child of the matched resource has the resourceType attribute the |
| | | same as the specified value. |
| parentResourceType | 0 . . . 1 | The parent of the matched resource has the resourceType attribute |
| | | the same as the specified value. |
| sizeAbove | 0 . . . 1 | The contentsize attribute of the <contentInstance> matched |
| | | resource is equal to or greater than the specified value. |
| sizeBelow | 0 . . . 1 | The contentsize attribute of the <contentInstance> matched |
| | | resource is smaller than the specified value. |
| contentType | 0 . . . n | The contentinfo attribute of the <contentInstance> matched |
| | | resource matches the specified value. |
| attribute | 0 . . . n | This is an attribute of resource types (clause 9.6). Therefore, a real |
| | | tag name is variable and depends on its usage and the value of the |
| | | attribute can have wild card *. E.g. creator of container resource |
| | | type can be used as a filter criteria tag as “creator = Sam”, |
| | | “creator = Sam*”, “creator = *Sam”. |
| childAttribute | 0 . . . n | A child of the matched resource meets the condition provided. |
| | | The evaluation of this condition is similar to the attribute |
| | | matching condition above. |
| parentAttribute | 0 . . . n | The parent of the matched resource meets the condition provided. |
| | | The evaluation of this condition is similar to the attribute |
| | | matching condition above. |
| semanticsFilter | 0 . . . n | Both semantic resource discovery and semantic query use |
| | | semanticsFilter to specify a query statement that shall be specified |
| | | in the SPARQL query language [5]. When a CSE receives a |
| | | RETRIEVE request including a semanticsFilter, and the Semantic |
| | | Query Indicator parameter is also present in the request, the |
| | | request shall be processed as a semantic query; otherwise, the |
| | | request shall be processed as a semantic resource discovery. |
| | | In the case of semantic resource discovery targeting a specific |
| | | resource, if the semantic description contained in |
| | | the <semanticDescriptor> of a child resource matches the |
| | | semanticFilter, the URI of this child resource will be included in |
| | | the semantic resource discovery result. |
| | | In the case of semantic query, given a received semantic query |
| | | request and its query scope, the SPARQL query statement shall be |
| | | executed over aggregated semantic information collected from the |
| | | semantic resource(s) in the query scope and the produced output |
| | | will be the result of this semantic query. |
| | | Examples for matching semantic filters in SPARQL to semantic |
| | | descriptions can be found in [i.28]. |
| filterOperation | 0 . . . 1 | Indicates the logical operation (AND/OR) to be used for different |
| | | condition tags. The default value is logical AND. |
| contentFilterSyntax | 0 . . . 1 | Indicates the Identifier for syntax to be applied for content-based |
| | | discovery. |
| contentFilterQuery | 0 . . . 1 | The query string shall be specified when contentFilterSyntax |
| | | parameter is present. |

TABLE 3

| | | |
|---|---|---|
| Condition tag | Multiplicity | Description |

Filter Handling Conditions

| | | |
|---|---|---|
| filterUsage | 0 . . . 1 | Indicates how the filter criteria is used. If provided, possible values |
| | | are ‘discovery’ and ‘IPEOnDemandDiscovery’. |
| | | If this parameter is not provided, the Retrieve operation is a |
| | | generic retrieve operation and the content of the child resources |
| | | fitting the filter criteria is returned. |
| | | If filterUsage is ‘discovery’, the Retrieve operation is for resource |
| | | discovery (clause 10.2.6), i.e. only the addresses of the child |
| | | resources are returned. |
| | | If filterUsage is ‘IPEOnDemandDiscovery’, the other filter |
| | | conditions are sent to the IPE as well as the discovery Originator |
| | | ID. When the IPE successfully generates new resources matching |
| | | with the conditions, then the resource address(es) shall be returned. |
| | | This value shall only be valid for the Retrieve request targeting |
| | | an <AE> resource that represents the IPE. |
| limit | 0 . . . 1 | The maximum number of resources to be included in the filtering |
| | | result. This may be modified by the Hosting CSE. When it is |
| | | modified, then the new value shall be smaller than the suggested |
| | | value by the Originator. |
| level | 0 . . . 1 | The maximum level of resource tree that the Hosting CSE shall |
| | | perform the operation starting from the target resource (i.e. To |
| | | parameter). This shall only be applied for Retrieve operation. The |
| | | level of the target resource itself is zero and the level of the direct |
| | | children of the target is one. |
| offset | 0 . . . 1 | The number of direct child and descendant resources that a Hosting |
| | | CSE shall skip over and not include within a Retrieve response |
| | | when processing a Retrieve request to a targeted resource. |
| applyRelativePath | 0 . . . 1 | This attribute contains a resource tree relative path |
| | | (e.g. . . . /tempContainer/LATEST). This condition applies after all |
| | | the matching conditions have been used (i.e. a matching result has |
| | | been obtained). The attribute determines the set of resource(s) in |
| | | the final filtering result. The filtering result is computed by |
| | | appending the relative path to the path(s) in the matching result. |
| | | All resources whose Resource-IDs match that combined path(s) |
| | | shall be returned in the filtering result. If the relative path does not |
| | | represent a valid resource, the outcome is the same as if no match |
| | | was found, i.e. there is no corresponding entry in the filtering |
| | | result. |

A response to a request for accessing a resource through the reference points Mca and Mcc may include at least one mandatory parameter and at least one optional parameter. In other words, each defined parameter may be either mandatory or optional according to a requested operation or a mandatory response code. For example, a request message may include at least one parameter among those listed in Table 4 below.

TABLE 4
Request message parameter

| | |
|---|---|
| Mandatory | Operation - operation to be executed/CREAT, Retrieve, Update, Delete, Notify |
| | To - the address of the target resource on the target CSE |
| | From - the identifier of the message Originator |
| | Request Identifier - uniquely identifies a Request message |
| Operation | Content - to be transferred |
| dependent | Resource Type - of resource to be created |
| Optional | Originating Timestamp - when the message was built |
| | Request Expiration Timestamp - when the request message expires |
| | Result Expiration Timestamp - when the result message expires |
| | Operational Execution Time - the time when the specified operation is to be |
| | executed by the target CSE |
| | Response Type - type of response that shall be sent to the Originator |
| | Result Persistence - the duration for which the reference containing the responses is |
| | to persist |
| | Result Content - the expected components of the result |
| | Event Category - indicates how and when the system should deliver the message |
| | Delivery Aggregation - aggregation of requests to the same target CSE is to be used |
| | Group Request Identifier - Identifier added to the group request that is to be fanned |
| | out to each member of the group |
| | Group Request Target Members-indicates subset of members of a group |
| | Filter Criteria - conditions for filtered retrieve operation |
| | Desired Identifier Result Type - format of resource identifiers returned |
| | Token Request Indicator - indicating that the Originator may attempt Token Request |
| | procedure (for Dynamic Authorization) if initiated by the Receiver |
| | Tokens - for use in dynamic authorization |
| | Token IDs - for use in dynamic authorization |
| | Role IDs - for use in role based access control |
| | Local Token IDs - for use in dynamic authorization |
| | Authorization Signature Indicator - for use in Authorization Relationship Mapping |
| | Authorization Signature - for use in Authorization Relationship Mapping |
| | Authorization Relationship Indicator - for use in Authorization Relationship |
| | Mapping |
| | Semantic Query Indicator - for use in semantic queries |
| | Release Version Indicator - the oneM2M release version that this request message |
| | conforms to. |
| | Vendor Information |

A normal resource includes a complete set of representations of data constituting the base of information to be managed. Unless qualified as either “virtual” or “announced”, the resource types in the present document may be normal resources. A virtual resource may be used to trigger processing and/or a retrieve result. However, a virtual resource may not have a permanent representation in a CSE. An announced resource may contain a set of attributes of an original resource. When an original resource changes, an announced resource may be automatically updated by the hosting CSE of the original resource. The announced resource contains a link to the original resource. Resource announcement enables resource discovery. An announced resource at a remote CSE may be used to create a child resource at a remote CSE, which may not be present as a child of an original resource or may not be an announced child thereof.

To support resource announcement, an additional column in a resource template may specify attributes to be announced for inclusion in an associated announced resource type. For each announced <resourceType>, the addition of suffix “Annc” to the original <resourceType> may be used to indicate its associated announced resource type. For example, resource <containerAnnc> may indicate the announced resource type for <container> resource, and <groupAnnc> may indicate the announced resource type for <group> resource.

Data leakage may be an issue in an IoT system. Anonymization and pseudonymization may be techniques to hide personal information. However, there may be other methods for supporting data protection. Allowing to have multiple values for a single resource (e.g., <contantInstance>) may be an alternative solution.

The basic concept of the data protection technique according to various embodiments may allow users to create multiple values for a single measurement. The owner of data may create multiple data points in an application measurement. Each content value has a different access type so that an application may see a different value depending on a specified access type.

FIG. 6 illustrates a concept of data with multiple values in an M2M system according to the present disclosure. Referring to FIG. 6, an IoT platform 620 may be configured to receive and store data with an original value generated by an IoT device 610. Herein, the IoT platform 620 may be configured to generate representation values 614a and 614b to protect an original value 612 and store the representation values together. FIG. 6 shows the two representation values 614a and 614b as examples, but one representation value or three or more representation values may be stored for the one original value 612. Accordingly, in case a retrieval request for the data occurs, the IoT platform 620 may provide the original value 612 to one device (e.g., device 1) and one of the representation values 614a and 614b to other devices (e.g., device 2 and device 3) according to a specified criterion. Thus, the original value 612 may be protected from other devices.

According to various embodiments, two options may be applied for generating data with multiple values. A first option may be to create a representation value. According to the first option, every request except specified members will see a representation value, and the representation value may be defined in a container. A second option may be to support multiple values in a resource (e.g., <contentInstance>). According to the second option, an original value may be stored in a first attribute (e.g., content), and a representation value may be stored in a second attribute (e.g., representationContent). In addition, one or more second attributes for storing a representation value may be created, and in this case, an owner may define who can see a content in which attribute. For example, the owner may see the actual content, while a family member may see a value in an attribute (e.g., representationContent1) storing a representation value, and others may see a value in an attribute (e.g., representationContent2) storing another representation value.

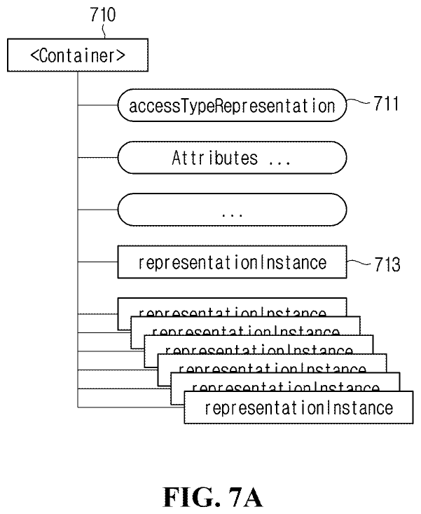

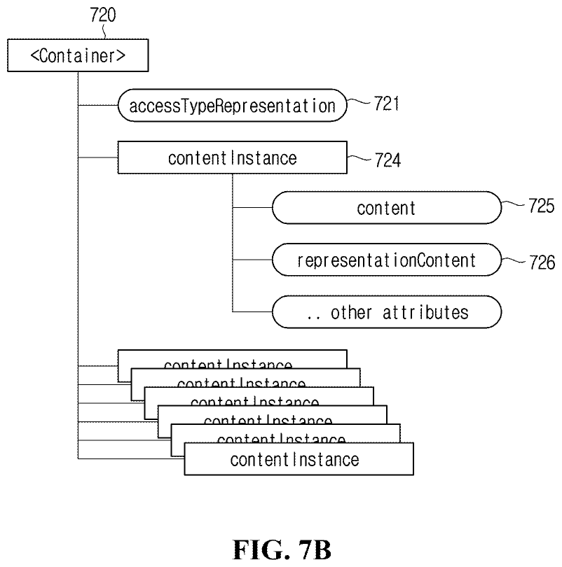

FIG. 7A and FIG. 7B illustrate examples of resources related to data with multiple values in an M2M system according to the present disclosure. FIG. 7A exemplifies a resource structure according to the first option, and FIG. 7B exemplifies a resource structure according to the second option.

Referring to FIG. 7A, an owner of an application creates a resource <container> 710 including a resource <representationInstance> 713. The resource <container> 710 may further include an attribute <accessTypeRepresentation> 711. The attribute <accessTypeRepresentation> 711 defines which access will see <represntationInstance> 713. That is, the attribute <accessTypeRepresenation> 711 may indicate an access type which may be designated to show a representation value. According to another embodiment, the attribute <accessTypeRepresenation> 711 may indicate an access type which may be designated to show a original value.

Referring to FIG. 7B, an owner of an application creates a resource <contentInstance> 724 including an attribute ‘representContent’ 726. The resource <contentInstance> 724 further includes an attribute ‘content’ 725 including an original value. The resource <contentInstance> 724 may be included in a resource <Container> 720, and the resource includes an attribute ‘accessTypeRepresentation’ 721. The attribute ‘accessTypeRepresentation’ 721 defines which access will see a value in the attribute ‘representationContent’ 726, not in the attribute ‘content’ 725.

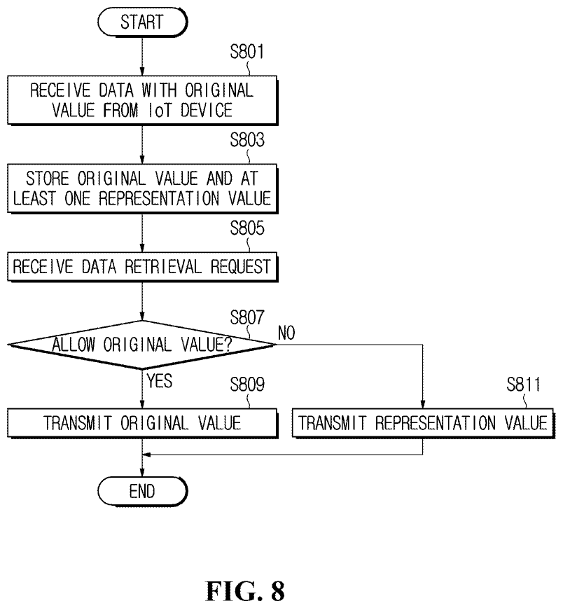

FIG. 8 illustrates an example of a procedure of processing data with multiple values in an M2M system according to the present disclosure. An operation subject of FIG. 8 may be a device (e.g., CSE) that manages a resource. In the description below, the operation subject of FIG. 8 is referred to as ‘device’.

Referring to FIG. 8, at step S801, the device receives data with an original value from an IoT device. The IoT device may be a device (e.g., sensor), which creates data during operation, and transmits the created data to store it in a resource. Herein, the device has a resource for storing data of the IoT device. According to an embodiment, the resource may include information associated with storing multiple values.

At step S803, the device stores an original value and at least one representation value. That is, the device may store not only the original value received from the IoT device but also at least one representation value for protecting the original value. To this end, according to an embodiment, the device may create at least one representation value corresponding to the original value. According to another example, the at least one representation value may be created by another device. In this case, the device may request the another device to create at least one representation value and receive the at least one representation value. At this time, the device may provide information on the original value to the another device. According to various embodiments, the at least one representation value may be created based on at least one of the original value and a random variable.

At step S805, the device receives a request for data retrieval. In other words, the device may transmit a message for requesting retrieval of data stored at step S803.The request for data retrieval may be received from an IoT device, which transmits the original value, and another device.

At step S807, the device determines whether or not reading the original is allowed. In other words, the device may determine whether or not another device requesting data retrieval has a right to read an original value of data. Whether or not the another device has the right to read the original value may be determined based on information on an access type included in a resource related to the IoT device. That is, based on information included in the resource related to the IoT device, the device determines whether or not to transmit the original value to the another device requesting data retrieval.

If reading the original is allowed, at step S809, the device transmits the original value. That is, in case the another device requesting data retrieval has a right to read the original, the device may transmit data including the original value. In other words, the device transmits the original value in response to the request at step S805.

On the other hand, if reading the original is not allowed, at step S811, the device transmits a representation value. Herein, when a plurality of representation values is stored, the device may select one of the plurality of representation values and transmit the selected representation value. Alternatively, the device may create a new representation value based on the plurality of representation values and transmit the created representation value.

As described in the embodiment with reference to FIG. 8, an original value may be protected using a representation value. To this end, prior to the procedure of FIG. 8, an operation of storing data with multiple values including an original value and at least one representation value (hereinafter referred to as multiple value storage) may be set. According to an embodiment, setting for multiple value storage may be performed during a registration procedure of an IoT device. Specifically, setting information may be added for multiple value storage in a resource for storage data created by an IoT device.

According to an embodiment, setting information may include at least one of information on generation and storage of a representation value and information on provision of a representation value. For example, the information on generation and storage of a representation value may indicate at least one of a creation time of a representation value, the number of representation values corresponding to one original value, and a creation algorithm of representation values. In addition, the information on provision of a representation value may indicate information (e.g., a device, a device type, an access type) for identifying a data request, to which a representation value is to be given as a response.

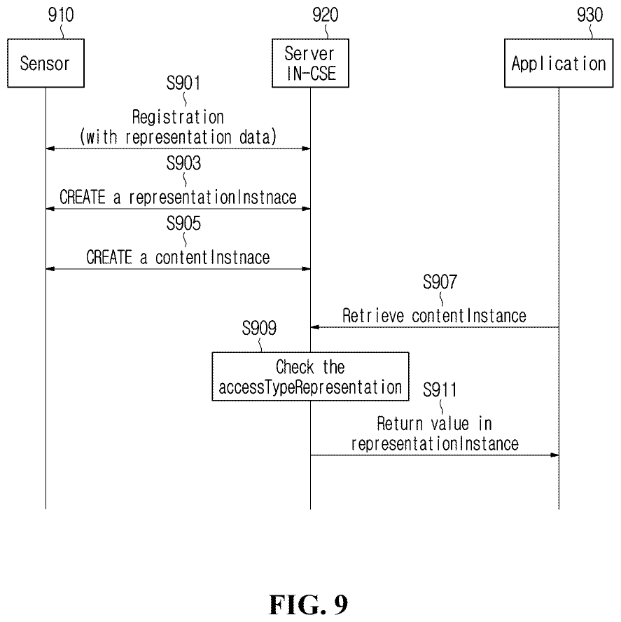

FIG. 9 illustrates an example of a procedure of generating and discovering data with multiple values in an M2M system according to the present disclosure. FIG. 9 exemplifies signal exchanges among a sensor 910 creating data, a server IN-CSE 920 storing data created by the sensor 910, and an application 930 requesting data retrieval.

Referring to FIG. 9, at step S901, the sensor 910 and the server IN-CSE 920 perform a registration procedure. To this end, the sensor 910 may transmit at least one message associated with registration to the server IN-CSE 920 and receive at least one message associated with registration from the server IN-CSE 920. At this time, a setting is added for storing data between the sensor 910 and the server IN-CSE 920 with multiple values. That is, the server IN-CSE 920 is set to store not only an original value but also at least one representation value, while storing data created by the sensor 910. In addition, the setting may include information for identifying devices which are allowed to read an original value.

At step S903, the sensor 910 and the server IN-CSE 920 perform a procedure for creating a resource (e.g., <representationInstance>) for storing a representation value. Herein, the resource (hereinafter referred to as representation value resource) for storing a representation value may be commonly used for various original values. Accordingly, the representation value resource may be created before a resource including an original value is created. That is, even when there is no original value, the server IN-C SE 920 may create a representation value. Furthermore, the server IN-C SE 920 may create and store at least one representation value in the representation value resource.

At step S905, the sensor 910 and the server IN-CSE 920 perform a procedure for creating a resource (e.g., <contentInstance>) for storing data including an original value. In other words, the server IN-CSE 920 creates a resource (hereinafter referred to as original value resource) for storing data including an original value associated with the representation value resource. For example, the sensor 910 may transmit data including an original value to the server IN-CSE 920, and the server IN-CSE 920 may create an original value resource and store the original value in the original value resource. As the original value is data that occurs during an operation of the sensor 910, the original value may have a different indication target according to a type of the sensor 910. The original value is a target to be protected by the proposed technique of the present disclosure and has a same type of information as representation values. Herein, although not illustrated in FIG. 9, the server IN-CSE 920 may create at least one representation value corresponding to the original value and store the at least one representation value thus created in a representation value resource. In FIG. 9, only one original value resource is created, but a plurality of original value may be created over time, and the step S905 may be performed repeatedly each time.

At step S907, the application 930 transmits a retrieval request for an original value resource (e.g., <contentInstance>) to the server IN-CSE 920. Along with the retrieval request, the application 930 may transmit information specifying data included in the original value resource that is created at step S905. In addition, the application 930 may transmit information associated with an access type of the application 930.

At step S909, the server IN-CSE 920 checks information (e.g., attribute accessTypeRepresentation) for identifying a device that has a right to read an original value created by the sensor 910. The information (hereinafter referred to as read right information) for identifying a device that has a right to read an original value is included in a resource that is created at step S901. The read right information may indicate a device, which has a right to read an original value, or a type or feature of the device or indicate a device, which reads a representation value instead of an original value, or a type or feature of the device. Herein, the feature may include an access type. In this case, the server IN-CSE 920 may determine whether or not the access type of the application 930 is an access type for which the read right information specifies to show a representation value. In this embodiment, the access type of the application 930 is an access type for which the read right information specifies to show a representation value. That is, the server IN-CSE 920 confirms, by checking the access type, that the application 930 is irrelevant to an owner of the sensor 910.

At step S911, the server IN-CSE 920 returns a representation value included in a representation value resource to the application 930. That is, the server IN-CSE 920 transmits, to the application 930, at least one of representation values included in the representation value resource. Thus, the server IN-CSE 920 can protect an original value from the application 930.

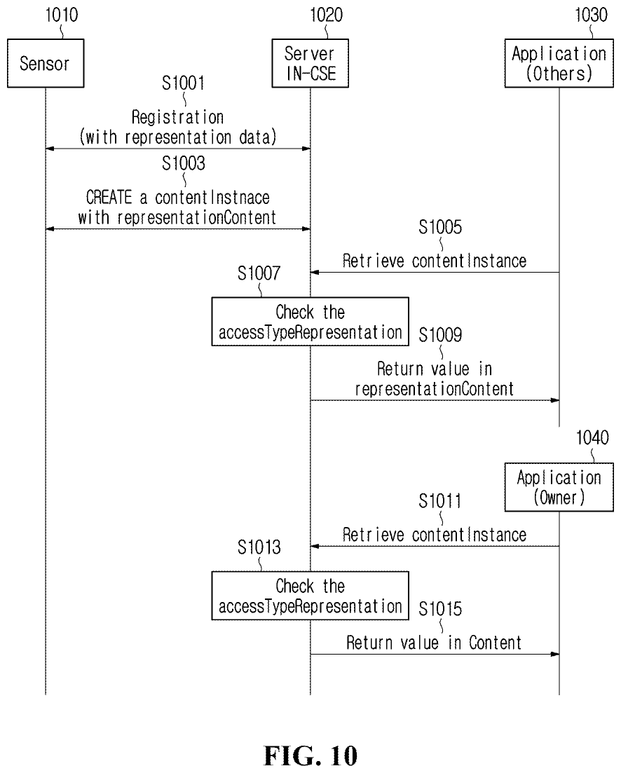

FIG. 10 illustrates another example of a procedure of generating and discovering data with multiple values in an M2M system according to the present disclosure. FIG. 10 exemplifies a signal exchange among a sensor 1010 that generates data, a server IN-CSE 1020 that stores data generated by the sensor 1010 in a resource, and an application 1030 that requests data retrieval.

Referring to FIG. 10, at step S1001, the sensor 1010 and the server IN-CSE 1020 perform a registration procedure. To this end, the sensor 1010 may transmit at least one message about registration to the server IN-CSE 1020 and receive at least one message about registration from the server IN-CSE 1020. At this time, a setting is added for storing data between the sensor 1010 and the server IN-CSE 1020 with multiple values. That is, the server IN-CSE 1020 is set to store not only an original value but also at least one representation value, while storing data created by the sensor 1010. In addition, the setting may include information for identifying devices which are allowed to read an original value.

At step S1003, the sensor 1010 and the server IN-CSE 1020 perform a procedure for creating a resource (e.g., <contentInstance>) for storing data including an original value including an attribute (e.g., representationContent) for storing a representation value. In other words, the server IN-CSE 1020 creates a resource (hereinafter referred to as content resource) including an attribute (e.g., content, hereinafter referred to as original value attribute) for storing an original value and an attribute (hereinafter referred to as representation value attribute) for storing a representation value. For example, the sensor 1010 may transmit data including an original value to the server IN-CSE 1020, and the server IN-CSE 1020 may create a content resource and store an original value in an original attribute and a representation value in a representation value attribute. As the original value is data that occurs during an operation of the sensor 1010, the original value may have a different indication target according to a type of the sensor 1010. The original value is a target to be protected by the proposed technique of the present disclosure and has a same type of information as representation values.

At step S1005, the application 1030 transmits a retrieval request for a content resource (e.g., <contentInstance>) to the server IN-CSE 1020. Together with the retrieval request, the application 1030 may transmit information specifying data included in the content resource that is created at step S1003. In addition, the application 1030 may transmit information associated with an access type of the application 1030.

At step S1007, the server IN-CSE 1020 checks information (e.g., attribute accessTypeRepresentation) for identifying a device that has a right to read an original value created by the sensor 1010. The information (hereinafter referred to as read right information) for identifying a device that has a right to read an original value is included in a resource that is created at step S1001. The read right information may indicate a device, which has a right to read an original value, or a type or feature of the device or indicate a device, which reads a representation value instead of an original value, or a type or feature of the device. Herein, the feature may include an access type. In this case, the server IN-CSE 1020 may determine whether or not the access type of the application 1030 is an access type for which the read right information specifies to show a representation value. In this embodiment, the access type of the application 1030 is an access type for which the read right information specifies to show a representation value.

At step S1009, the server IN-CSE 1020 returns a representation value included in a representation value attribute to the application 1030. That is, the server IN-CSE 1020 transmits, to the application 1030, at least one of representation values included in the representation value attribute. Accordingly, the server IN-CSE 1020 can protect an original value from the application 1030.

At step S1011, the application 1040 transmits a retrieval request for a content resource (e.g., <contentInstance>) to the server IN-CSE 1020. Together with the retrieval request, the application 1040 may transmit information specifying data included in the content resource that is created at step S1003. In addition, the application 1040 may transmit information associated with an access type of the application 1040.

At step S1013, the server IN-CSE 1020 checks information (e.g., attribute accessTypeRepresentation) for identifying a device that has a right to read an original value created by the sensor 1010. The information (hereinafter referred to as read right information) for identifying a device that has a right to read an original value is included in a resource that is created at step S1001. The read right information may indicate a device, which has a right to read an original value, or a type or feature of the device or indicate a device, which reads a representation value instead of an original value, or a type or feature of the device. Herein, the feature may include an access type. In this case, the server IN-CSE 1020 may determine whether or not the access type of the application 1040 is an access type for which the read right information specifies to show a representation value. In this embodiment, the access type of the application 1040 is an access type for which the read right information specifies to show an original value. That is, the server IN-CSE 1020 confirms, by checking the access type, that the application 1040 is related to an owner of the sensor 1010.

At step S1015, the server IN-CSE 1020 returns an original value included in an original value attribute to the application 1040. That is, the server IN-CSE 1020 transmits the original value to the application 1040.

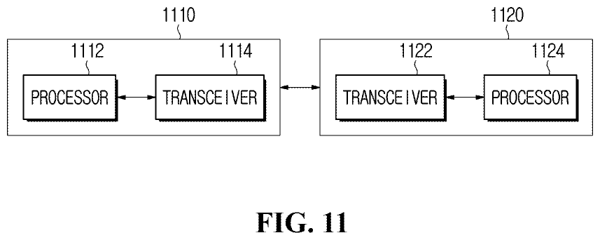

FIG. 11 illustrates a configuration of an M2M device in an M2M system according to the present disclosure. An M2M device 1110 or an M2M device 1120 illustrated in FIG. 11 may be understood as hardware functioning as at least one among the above-described AE, CSE and NSE.

Referring to FIG. 11, the M2M device 1110 may include a processor 1112 controlling a device and a transceiver 1114 transmitting and receiving a signal. Herein, the processor 1112 may control the transceiver 1114. In addition, the M2M device 1110 may communicate with another M2M device 1120. The another M2M device 1120 may also include a processor 1122 and a transceiver 1124, and the processor 1122 and the transceiver 1124 may perform the same function as the processor 1112 and the transceiver 1114.

As an example, the originator, the receiver, AE and CSE, which may be described above, may be one of the M2M devices 1110 and 1120 of FIG. 11, respectively. In addition, the devices 1110 and 1120 of FIG. 11 may be other devices. As an example, the devices 1110 and 1120 of FIG. 11 may be communication devices, vehicles, or base stations. That is, the devices 1110 and 1120 of FIG. 11 refer to devices capable of performing communication and may not be limited to the above-described embodiment.

The above-described exemplary embodiments of the present disclosure may be implemented by various means. For example, the exemplary embodiments of the present disclosure may be implemented by hardware, firmware, software, or a combination thereof.

The foregoing description of the exemplary embodiments of the present disclosure has been presented for those skilled in the art to implement and perform the disclosure. While the foregoing description has been presented with reference to the preferred embodiments of the present disclosure, it will be apparent to those skilled in the art that various modifications and variations may be made in the present disclosure without departing from the spirit or scope of the present disclosure as defined by the following claims.

Accordingly, the present disclosure is not intended to be limited to the exemplary embodiments shown herein but is to be accorded the widest scope consistent with the principles and novel features disclosed herein. In addition, while the exemplary embodiments of the present specification have been particularly shown and described, it is to be understood that the present specification is not limited to the above-described exemplary embodiments, but, on the contrary, it will be understood by those skilled in the art that various changes and modifications may be made without departing from the spirit and scope of the present specification as defined by the claims below, and such changes and modifications should not be individually understood from the technical thought and outlook of the present specification.

In this specification, both the disclosure and the method disclosure are explained, and the description of both disclosures may be supplemented as necessary. In addition, the present disclosure has been described with reference to exemplary embodiments thereof. It will be understood by those skilled in the art that various changes in form and details may be made therein without departing from the essential characteristics of the present disclosure. Therefore, the disclosed exemplary embodiments should be considered in an illustrative sense rather than in a restrictive sense. The scope of the present disclosure is defined by the appended claims rather than by the foregoing description, and all differences within the scope of equivalents thereof should be construed as being included in the present disclosure.

What is claimed is:

1. A method for operating a first device in a machine-to-machine (M2M) system, the method comprising:
receiving, from a second device, data including the original value generated by the second device;
obtaining at least one representation value corresponding to the original value; and
storing the original value and the at least one representation value in a resource for storing the data generated by the second device.

2. The method of claim 1, further comprising generating the resource,
wherein the resource includes at least one of first information on generation and storage of a representation value and second information on provision of the representation value.

3. The method of claim 2, wherein the resource is generated during a registration procedure for the second device.

4. The method of claim 2, wherein the second information is information for identifying a data request, which is configured to be responded by the at least one representation value, and indicates an access type.

5. The method of claim 1, further comprising:
receiving a retrieval request for data stored in the resource from a third device;
confirming that the third device has no right to read the original value; and
transmitting, in response to the retrieval request, one representation value of the at least one representation value to the third device.

6. The method of claim 5, wherein the confirming that the third device has no right to read the original value comprises confirming, based on an access type of the third device, that the third device is a device irrelevant to an owner of the second device.

7. The method of claim 1, further comprising:
receiving a retrieval request for data stored in the resource from a fourth device;
confirming that the fourth device has right to read the original value; and
transmitting, in response to the retrieval request, the original value to the fourth device.

8. The method of claim 7, wherein the confirming that the fourth device has right to read the original value comprises confirming, based on an access type of the fourth device, that the fourth device is a device related to the owner of the second device.

9. The method of claim 1, wherein the resource includes a sub-resource for storing the original value, and
wherein the sub-resource includes an attribute for storing the original value and an attribute for storing the at least one representation value.

10. The method of claim 1, wherein the resource includes a sub-resource for storing the original value and a sub-resource for storing the at least one representation value.

11. A first device in a machine-to-machine (M2M) system, comprising:
a transceiver; and
a processor coupled with the transceiver,
wherein the processor is configured to:
receive, from a second device, data including an original value generated by the second device,
obtain at least one representation value corresponding to the original value, and
store the original value and the at least one representation value in a resource for storing the data generated by the second device.

12. The first device of claim 11, wherein the processor is further configured to generate the resource, and
wherein the resource includes at least one of first information on generation and storage of a representation value and second information on provision of the representation value.

13. The first device of claim 12, wherein the resource is configured to be generated during a registration procedure for the second device.

14. The first device of claim 12, wherein the second information is information for identifying a data request, which is to be responded by the at least one representation value, and indicates an access type.

15. The first device of claim 11, wherein the processor is further configured to:
receive a retrieval request for data stored in the resource from a third device,
confirm that the third device has no right to read the original value, and
transmit, in response to the retrieval request, one representation value of the at least one representation value to the third device.

16. The first device of claim 15, wherein the processor is further configured to confirm, based on an access type of the third device, that the third device is a device irrelevant to an owner of the second device.

17. The first device of claim 11, wherein the processor is further configured to:
receive a retrieval request for data stored in the resource from a fourth device,
confirm that the fourth device has right to read the original value, and
transmit, in response to the retrieval request, the original value to the fourth device.

18. The first device of claim 17, wherein the processor is further configured to confirm, based on an access type of the fourth device, that the fourth device is a device related to the owner of the second device.

19. The first device of claim 11, wherein the resource includes a sub-resource for storing the original value, and
wherein the sub-resource includes an attribute for storing the original value and an attribute for storing the at least one representation value.

20. The first device of claim 11, wherein the resource includes a sub-resource for storing the original value and a sub-resource for storing the at least one representation value.
